(19) United States
(12) Patent Application Publication
(10) Pub. No.: US 2019/0259201 A1
(43) Pub. Date: Aug. 22, 2019

(54) SYSTEMS AND METHODS FOR GENERATING OR SELECTING DIFFERENT LIGHTING DATA FOR A VIRTUAL OBJECT

(71) Applicant: Tsunami VR, Inc., Del Mar, CA (US)

(72) Inventors: Anthony DUCA, Carlsbad, CA (US); David ROSS, San Diego, CA (US)

(21) Appl. No.: 16/282,019

(22) Filed: Feb. 21, 2019

Related U.S. Application Data
(60) Provisional application No. 62/633,581, filed on Feb. 21, 2018.
(60) Provisional application No. 62/638,567, filed on Mar. 5, 2018.
(60) Provisional application No. 62/633,579, filed on Feb. 21, 2018.

(51) Int. Cl. G06T 15/50; G06T 15/20; G06T 19/00; G06T 19/20

(52) U.S. Cl. CPC G06T 15/506; G06T 19/20; G06T 19/003; G06T 15/205

(57) ABSTRACT

Systems, methods, and computer-readable media for operating a virtual environment are provided. The method can include transmitting virtual object data to a user device for rendering a virtual object having one or more parts. The method can include determining a current position of the user device and a current position of a virtual object based on a mapping of the virtual environment. The method can include determining current lighting information for the virtual environment based on the current position, including brightness information for of one or more light sources in the virtual environment during the current time period. The method can include generating new lighting data for each part of the one or more parts of the virtual object and transmitting the new lighting data to the user device for each part of the virtual object.

### CROSS REFERENCE TO RELATED APPLICATIONS

This application claims priority to U.S. Provisional Patent Application Ser. No. 62/633,581, filed Feb. 21, 2018, entitled “SYSTEMS AND METHODS FOR GENERATING DIFFERENT LIGHTING DATA FOR A VIRTUAL OBJECT,” to U.S. Provisional Patent Application Ser. No. 62/638,567, filed Mar. 5, 2018, entitled “SYSTEMS AND METHODS FOR GENERATING OR SELECTING DIFFERENT LIGHTING DATA FOR A VIRTUAL OBJECT,” and U.S. Provisional Patent Application Ser. No. 62/633,579, filed Feb. 21, 2018, entitled “SYSTEMS AND METHODS FOR GENERATING VISUAL REPRESENTATIONS OF A VIRTUAL OBJECT FOR DISPLAY BY USER DEVICES,” the contents of which are hereby incorporated by reference in their entirety.

### BACKGROUND

### Technical Field

This disclosure relates to virtual reality (VR), augmented reality (AR), and mixed reality (MR) technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, virtual reality (VR), and augmented reality (AR) via immersive technology including interactive environments and interactive three-dimensional (3D) virtual objects. Users of MR visualizations and environments can move around the MR visualizations and interact with virtual objects within the virtual environment.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics.

MR, VR, and AR (or similar) devices can provide complex features and high-fidelity of representations of a physical world that can be useful in instruction or various types of training curricula or programs.

### SUMMARY

An aspect of the disclosure provides a method for operating a virtual environment. The method can include transmitting, by one or more processors, virtual object data to a user device for rendering a virtual object at the user device, the virtual object having one or more parts. The method can include determining, during a current time period, a current position of the user device and a current position of a virtual object based on a mapping of the virtual environment received from the user device. The method can include determining current lighting information for the virtual environment based on the current position, the lighting information including brightness information for of one or more light sources in the virtual environment during the current time period. The method can include generating new lighting data for each part of the one or more parts of the virtual object for a subsequent time period after the current period of time. The method can include transmitting the new lighting data to the user device for each part of the virtual object.

The method can include generating the new lighting data for the subsequent time period based on at least one of a change in relative position between the user device and the virtual object, a change in lighting information, an absence of current lighting data, and
an expiration of a predefined time since the current lighting data.

The method can include selecting, from among a plurality of previously-generated lighting data previously-generated lighting information that best matches the current lighting information for the environment. The method can include transmitting previously-generated lighting data associated with the previously-generated lighting information to the user device based on the selecting.

The method can include generating the new lighting data for each part based on a most-recent lighting information for the environment and the current position of the virtual object if each of the plurality of previously-generated lighting data fails a threshold test.

The method can include determining a current distribution of lighting of the environment based on a most-recent lighting information. The method can include determining a distribution of lighting within the virtual environment for which the previously-generated lighting information was captured.

Determining the current lighting information for the virtual environment for an AR user device can include capturing the current lighting information for a physical environment coincident with the virtual environment.

Determining the current lighting information for the virtual environment for a VR user device can include retrieving the current lighting information for the environment.

The current lighting information can include a position of one or more light sources and brightness of the one or more light sources.

The method can include determining a current time of day for the user device.

The method can include selecting, for inclusion with the virtual object data, default lighting data previously generated based on predefined lighting conditions for a time of day that matches or includes the current time of day.

The method can include determining whether the environment is an indoor or outdoor environment. The method can include selecting, for inclusion with the virtual object data, default lighting data previously generated based on predefined lighting conditions for the determined indoor or outdoor environment.

Another aspect of the disclosure provides a non-transitory computer-readable medium for operating a virtual environment. The non-transitory computer-readable medium can include instructions that cause one or more processors cause to transmit virtual object data to a user device for rendering a virtual object at the user device, the virtual object having one or more parts. The instructions can further cause the one or more processors to determine, during a current time period, a current position of the user device and a current position of a virtual object based on a mapping of the virtual environment received from the user device. The instructions can further cause the one or more processors to determine current lighting information for the virtual environment based on the current position, the lighting information including brightness information for of one or more light sources in the virtual environment during the current time period. The instructions can further cause the one or more processors to generate new lighting data for each part of the one or more parts of the virtual object for a subsequent time period after the current period of time. The instructions can further cause the one or more processors to transmit the new lighting data to the user device for each part of the virtual object.

Other features and advantages will be apparent to one of skill in the art with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of system for creating computer-generated virtual environments and providing the virtual environments as an immersive experience for VR, AR and/or MR users;

FIG. 1B is a functional block diagram of user device for use with the system of FIG. 1;

FIG. 2 is a flowchart of an embodiment of a process for generating different lighting data for a virtual object;

FIG. 3 is a flowchart of an embodiment of a process for selecting pre-computed lighting data for a virtual object to display within a virtual or physical environment in response to detecting different lighting conditions of the environment over time;

FIG. 4A is a flowchart of an embodiment of a process for retrieving virtual object data;

FIG. 4B is a flowchart of another embodiment of a process for retrieving virtual object data;

FIG. 4C is a flowchart of another embodiment of a process for retrieving virtual object data;

FIG. 5A is a flowchart of an embodiment of a process for selecting previously-generated lighting data that best matches the most-recent lighting information for the environment;

FIG. 5B is a flowchart of another embodiment of a process for selecting previously-generated lighting data that best matches the most-recent lighting information for the environment;

FIG. 5C is a flowchart of another embodiment of a process for selecting previously-generated lighting data that best matches the most-recent lighting information for the environment;

FIG. 5D is a flowchart of another embodiment of a process for selecting previously-generated lighting data that best matches the most-recent lighting information for the environment; and

FIG. 6 is a flowchart of an embodiment of a process for generating or selecting different lighting data for the same virtual object in response to detecting different lighting conditions in different virtual or physical environments.

### DETAILED DESCRIPTION

This disclosure relates to different approaches for generating or selecting different lighting data for a virtual object at a server.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics of each of the described embodiments may be combined in any suitable manner in one or more embodiments.

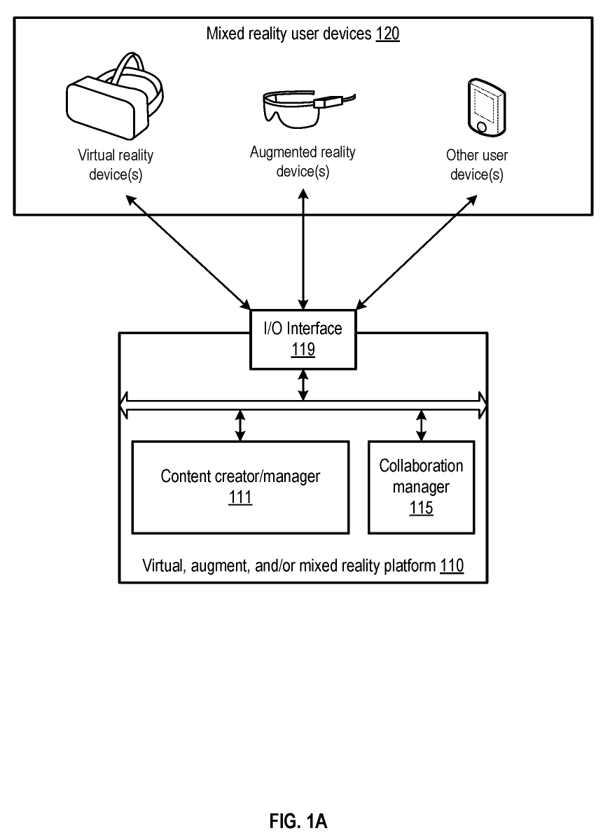

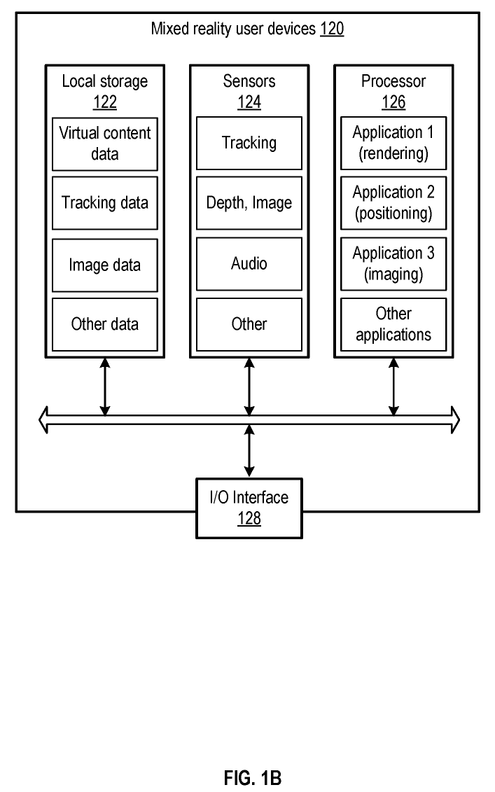

FIG. 1A is a functional block diagram of system for creating computer-generated virtual environments and providing the virtual environments as an immersive experience for VR, AR and/or MR users. Embodiments of the system depicted in FIG. 1A include a system on which a VR device can emulate user experience of an AR device. The system includes a mixed reality platform 110 that is communicatively coupled to any number of mixed reality user devices 120 such that data can be transferred between them as required for implementing the functionality described in this disclosure. General functional details about the platform 110 and the user devices 120 are discussed below before particular functions involving the platform 110 and the user devices 120 are discussed. The platform 110 may include one or more servers, and may also be referred to herein as a server.

As shown in FIG. 1A, the platform 110 includes different architectural features, including a content manager 111, a content creator 113, a collaboration manager 115, and an input/output (I/O) interface 119. The content creator 113 creates a virtual environment, and also creates visual representations of things as virtual content (e.g., virtual objects, avatars, video, images, text, audio, or other presentable data) that can be displayed in a virtual environment depending on a user's point of view. Raw data may be received from any source, and then converted to virtual representations of that data (i.e., virtual content). Different versions of virtual content may also be created and modified using the content creator 113. The content manager 111 stores content created by the content creator 113, stores rules associated with the content, and also stores user information (e.g., permissions, device type, or other information). The collaboration manager 115 provides portions of a virtual environment and virtual content to each of the user devices 120 based on conditions, rules, poses (e.g., positions and orientations) of users in a virtual environment, interactions of users with virtual content, and other information. The I/O interface 119 provides secure transmissions between the platform 110 and each of the user devices 120.

FIG. 1B is a functional block diagram of user device for use with the system of FIG. 1. Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual content or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of user devices 120 include head-mounted displays, AR glasses, smart phones and other computing devices capable of displaying virtual content, and other suitable devices. By way of example, AR devices may include glasses, goggles, a smart phone, or other computing devices capable of projecting virtual content on a display of the device so the virtual content appears to be located in a physical space that is in view of a user.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine fields of view, and each field of view is used to determine what virtual content is to be rendered using the processor 126 for presentation to the user on a display of a user device. Rendering can refer to performing the calculations necessary to assimilate a virtual scene for a given virtual environment. The output of the rendering can be a collection of scene data which includes geometry, viewpoint, texture, lighting, and shading information. The scene data is used to generate a pixelated version to display on 3D capable user device. In some examples, the rendering can also generate a photorealistic or non-photorealistic image from a 2D or 3D model. Tracking the positions and orientations of the user or any user input device (e.g., a handheld device) may also be used to determine interactions with virtual content. In some embodiments, an interaction with virtual content (e.g., a virtual object) includes a modification (e.g., change color or other) to the virtual content that is permitted after a tracked position of the user or user input device intersects with a point of the virtual content in a geospatial map of a virtual environment, and after a user-initiated command is provided to make the desired modification. Positions in a physical environment may be tracked in different ways, including positioning using Global Navigation Satellite Systems (GNSS), Bluetooth, WiFi, an altimeter, or any other known way to estimate the position of a thing (e.g., a user) in a physical environment.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual content among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, MR and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

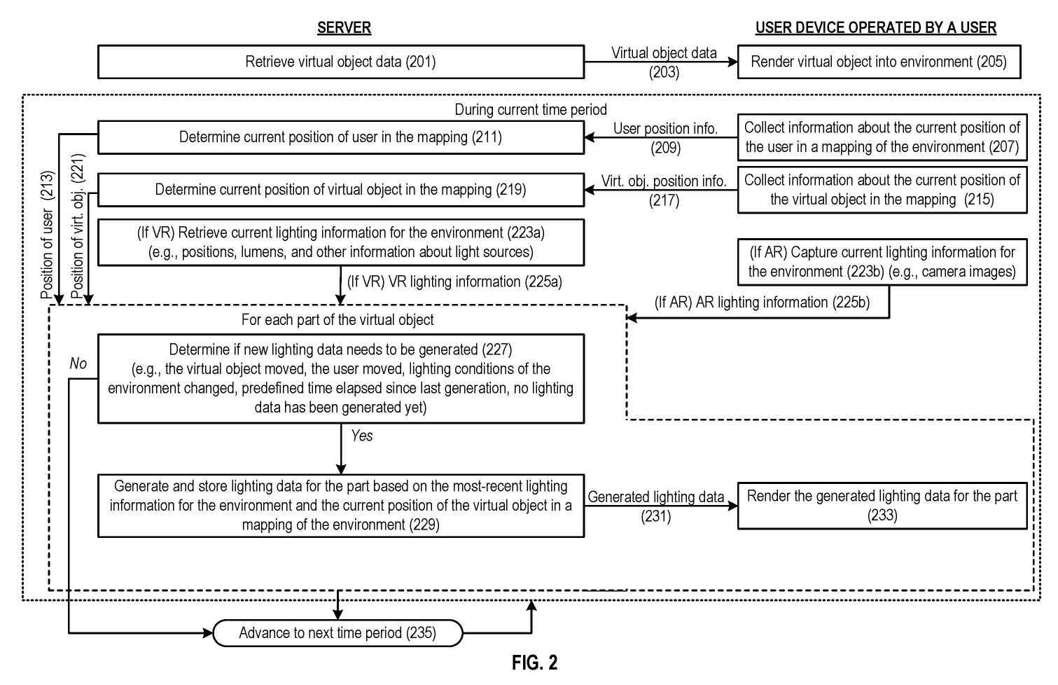

The methods or processes outlined and described herein and particularly those that follow below in connection with FIG. 2 through FIG. 6, can be performed by one or more processors of the platform 110 (e.g., one or more servers) either alone or in connection or cooperation with the user device(s) 120. The processes can also be performed using distributed or cloud-based computing.

### Generating Different Lighting Data for a Virtual Object to Display in a Virtual or Physical Environment in Response to Detecting Different Lighting Conditions of the Environment over Time

More accurate and/or more precise lighting data can provide a more photo-realistic user experience. Updating scene data (e.g., rapidly or in real time) based on changes in lighting can require significant computing power. In some exemplary implementations described below, the server (e.g., the platform 110) can perform at least some, a majority, or all of such processing, (e.g., “the heavy lifting”) and provide lighting data to the user device. The user device 120 can then receive in implement the lighting data and/or lighting information to update the local scene data within the virtual environment. Accordingly, certain rendering processes can be divided between the server and the user device. In some examples, the user device can determine the view of the user and the server can provide the lighting data to provide a photo-realistic view of the virtual environment to the user device. Various exemplary implementations of such processes are described herein.

FIG. 2 is a flowchart of an embodiment of a process for generating different lighting data for a virtual object. FIG. 2 includes headings across the top that indicate which steps of the described process are performed by the “server” (e.g., the platform 110) and the “user device operated by a user” (e.g., the user device 120). The process of FIG. 2 can be performed by the platform 110 in cooperation with the user device 120 to display one or more virtual objects within a virtual environment in response to detecting different lighting conditions of the environment over time. The virtual environment can include a virtual reality environment as viewed through, for example, a VR headset. The virtual environment can also include perspectives of the physical world as view through an AR or MR user device having additional (virtual) information projected or otherwise overlaid on top of the physical world/environment.

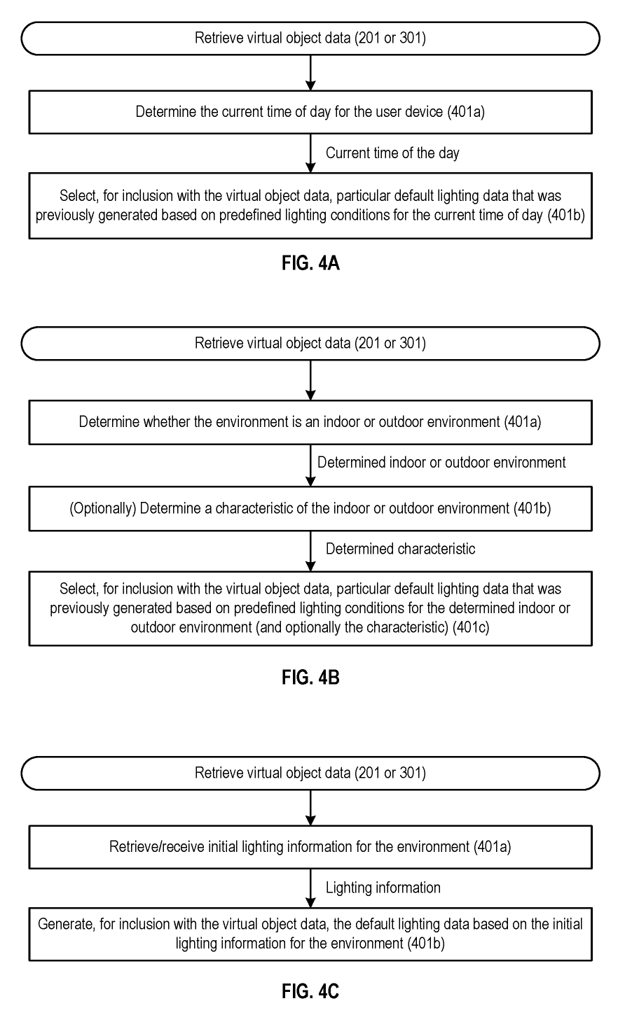

As shown in FIG. 2, virtual object data is initially retrieved (201) at the platform 110 (server) before being transmitted (203) so a user device operated by a user can render the virtual object into an environment (e.g., a virtual environment or a physical environment) (205). Virtual object data may come in different forms. By way of example, virtual object data may include: geometry data, default lighting data, and other data (e.g., animation data, or other data known in the art). As is known, lighting data may include light maps that include baked self-shadows, lighting, reflections, global illumination, ambient occlusion, or other lighting effects onto a surface of a virtual object. In one embodiment, the default lighting data includes a default light map that is based on predefined lighting around a virtual object, where the light map shows self-shadowing of the virtual object given the predefined lighting. In another embodiment, the default lighting data includes a light map that is selected using any of the processes shown in FIG. 4A through FIG. 4C, described below. After receiving the virtual object data, the user device renders the virtual object using the default lighting data. Any known process may be used to render the virtual object to display on a screen of the user device.

During a current time period, the following steps are performed: collect, using the user device, information about the current position of the user in a mapping of the environment (207); transmit the information about the current position of the user to the server (e.g., the platform 110) (209); determine, using the user device, the current position of the user in the mapping of the environment based on the position information of the user (211); make, using the server, the current positon of the user available (213); collect, using the user device, information about the current position of the virtual object in a mapping of the environment (215); transmit the information about the current position of the virtual object from the user device to the server (217); determine, using the server, the current position of the virtual object in the mapping of the environment based on the position information of the virtual object (219); and make, using the server, the current positon of the virtual object available (221). As used herein, a current time period can include a period of time belonging to a present time, that is something happening or being used or done now. Current can thus be distinguished from a subsequent time period that happens after the current time period. The amount of time in a “period” can be user defined. It can be seconds, minutes, hours, or fractions of any of the above. The time periods can include shorter periods of time, including milliseconds. The user-selected or otherwise predefined periods of time can vary according to the environment, time of day, activity, operation, or other aspects.

Lighting information within a virtual environment (e.g., the virtual reality environment for a VR user, or virtual environment overlaid on a physical world for an AR/MR user) can affect the way certain virtual content (e.g., the virtual objects) are displayed. Lighting information, as used herein can refer generally to information about the light sources, such as position, color, intensity, and brightness, for example. Specific aspects may be identified for VR/AR/MR implementations.

For example, if the user device is a VR device, the server can retrieve current lighting information for the virtual environment using known techniques of retrieval during the current time period (223a), and the resulting VR lighting information is made available for later use (225a) by the user device. Examples of VR lighting information include: positions, directions, intensities (e.g., lumens), and other information about light sources in the environment; if reflections are to be determined for inclusion in lighting data, information about reflections (e.g., colors and positions of other objects relative to reflective surfaces of the virtual object as may be determined using known approaches).

If the user device is an AR device, the user device captures current lighting information for the physical environment using known techniques of capturing during the current time period (223b), and the resulting AR lighting information is made available for later use (225b). Examples of AR lighting information include images captured by a camera of the AR device; if reflections are to be determined for inclusion in lighting data, information about reflections (e.g., colors and positions of other objects relative to reflective surfaces of the virtual object as may be determined using known approaches like a depth sensor and camera of an AR device).

During the current time period, and for each of a plurality of parts of the virtual object, a determination is made as to whether new lighting data needs to be generated for a surface of that part (227). When the current time period is the first of two or more time periods in some embodiments, (i) step 227 may not be performed such that the process continues to step 229, or (ii) the determination during step 227 may simply be a determination that no lighting data has been generated yet after which the process continues to step 229. When the current time period is the second or later time period of two or more time periods (or possibly the first time period in some embodiments), detection of different conditions may be used to implement the determination of step 227. In one embodiment, new lighting data is not needed unless movement of the user to a new position in a mapping of the environment is detected (e.g., the current position of the user is different than a previous position of the user, movement is detected using inertial sensors of the user device, or another approach). This can include changes in relative position or aspect between the user device and the virtual object.

In some embodiments, new lighting data is not needed unless movement of the virtual object to a new position in a mapping of the environment is detected (e.g., the current position of the virtual object is different than a previous position of the virtual object). In another embodiment, new lighting data is not needed unless movement of the virtual object to a new orientation in a mapping of the environment is detected (e.g., the current orientation of the virtual object is different than a previous orientation of the virtual object). In yet another embodiment, new lighting data is not needed unless a change to lighting conditions of the environment is detected (e.g., a position, direction, and/or intensity of a light source is different than a previous position, direction, and/or intensity of the light source; e.g., a new light source is detected; e.g., a previous light source is no longer detected). In yet another embodiment, new lighting data is not needed unless a predefined elapsed time (e.g., t units of time) has passed since last generation of lighting data. In yet another embodiment, new lighting data is not needed unless placement of another object (virtual or physical) between a light source and the virtual object is detected, or unless movement by another object (virtual or physical) that is placed within a mapping of the environment is detected.

In other embodiments, new lighting data is not needed unless the difference between current and previous values exceeds a threshold value: e.g., the amount of distance the user moved exceeds a threshold amount of distance that is predefined for users; e.g., the amount of distance the virtual object moved exceeds a threshold amount of distance that is predefined for virtual objects; e.g., the amount of change to the orientation of the virtual object exceeds a threshold amount of two-dimensional or three-dimensional rotation or other type of change to orientation; e.g., the amount of change to the lighting conditions exceeds a threshold amount of change (e.g., threshold amounts of movement between positions of light sources, threshold amounts of rotation between directions of light sources, threshold amounts of intensities from light sources).

Any combination of the preceding embodiments of step 227 is also contemplated (e.g., new lighting data is not needed unless any condition of two or more conditions is detected; e.g., new lighting data is not needed unless any number of conditions of two or more conditions are detected).

If new lighting data is needed, lighting data for the part is generated based on the most-recent lighting information received for the environment (229). The current position of the virtual object relative to lights in a mapping of the environment may also be used to generate the lighting data for the part during step 229. Any known approach for generating lighting data based on lighting information for an environment may be used, including: ray tracing, global illumination, ambient occlusion, image-based lighting (e.g., as determined from a high-dynamic range image), among others known in the art.

After step 229, the generated lighting data is transmitted to the user device from the server (231), and the user device renders the generated lighting data for the part using known approaches for rendering (e.g., by mapping the lighting data to geometry data of the virtual object) (233).

If new lighting data is not needed, or after step 229, the process waits for a new time period (235) before repeating steps 211 through 235 during the new time period.

### Selecting Pre-computed Lighting Data for a Virtual Object to Display within a Virtual or Physical Environment in Response to Detecting Different Lighting Conditions of the Environment over Time

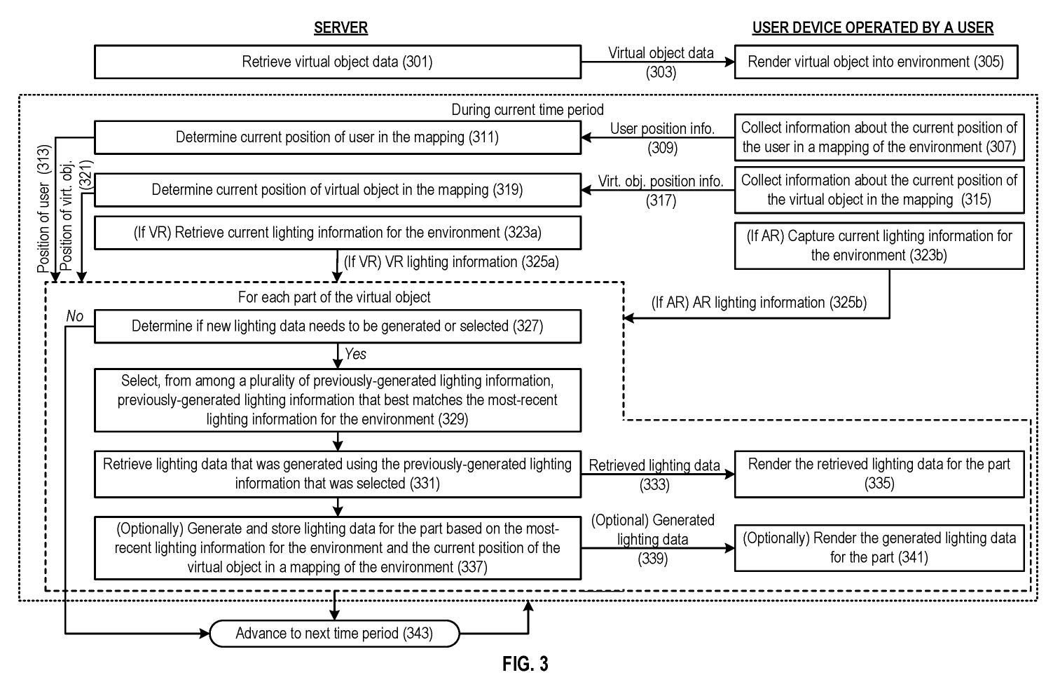

FIG. 3 is a flowchart of an embodiment of a process for selecting pre-computed lighting data for a virtual object to display within a virtual or physical environment in response to detecting different lighting conditions of the environment over time. Similar to FIG. 2, FIG. 3 includes headings across the top that indicate which steps of the described process are performed by the “server” (e.g., the platform 110) and the “user device operated by a user” (e.g., the user device 120).

As shown in FIG. 3, virtual object data is initially retrieved (301) before being transmitted (303) so a user device operated by a user can render the virtual object into an environment (e.g., a virtual environment or a physical environment) (305). The steps 301 through 305 can be similar to the embodiments described for steps 201 through 205 of FIG. 2.

Steps 307 through 327 of FIG. 3 can be the same steps or similar steps as steps 207 through 227 of FIG. 2.

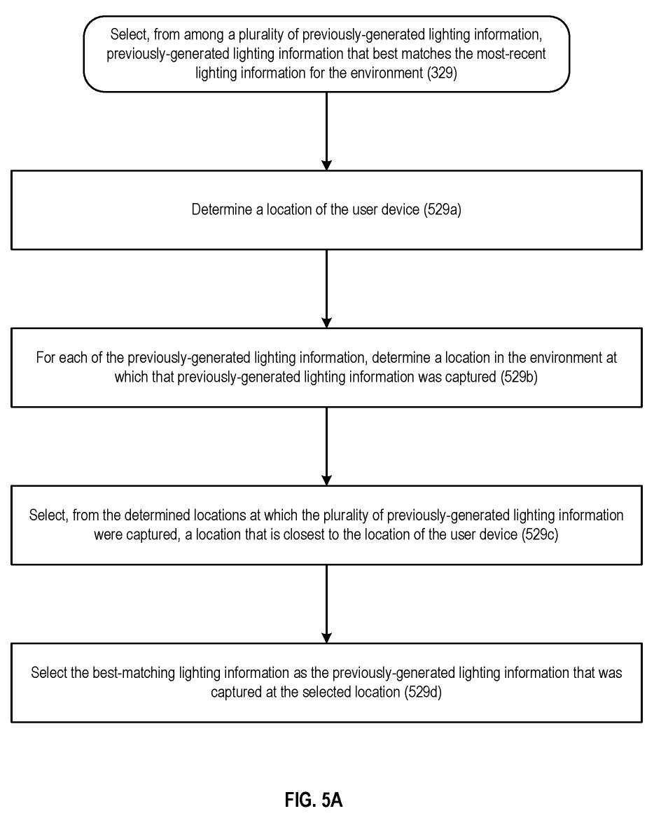

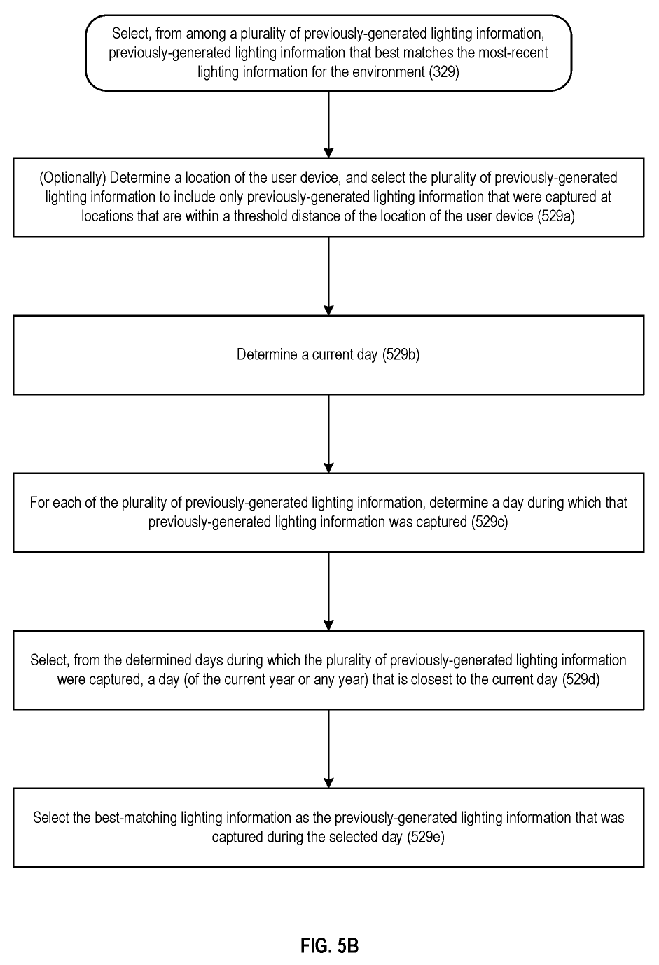

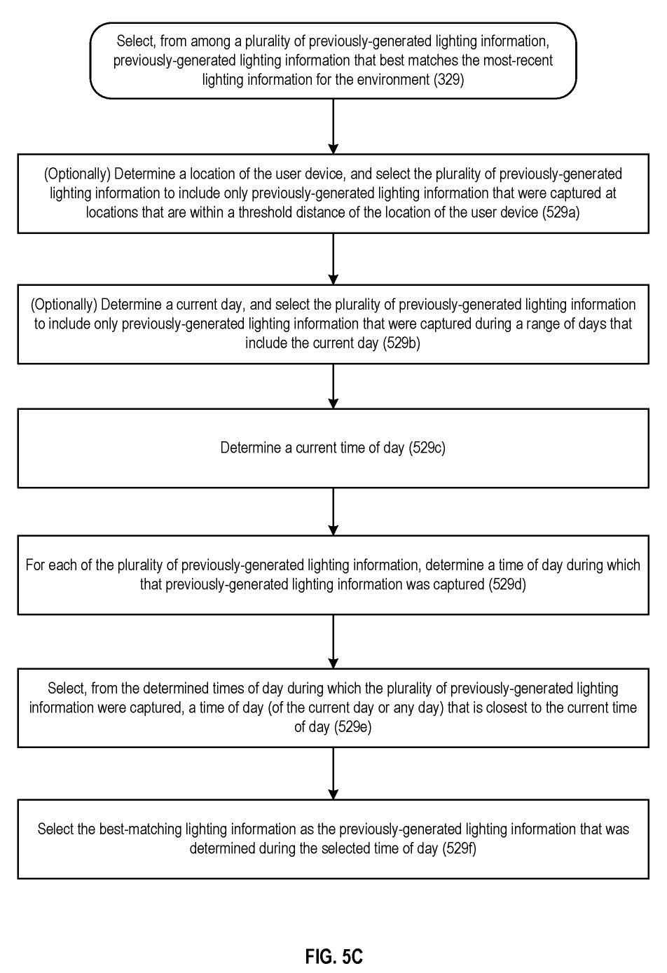

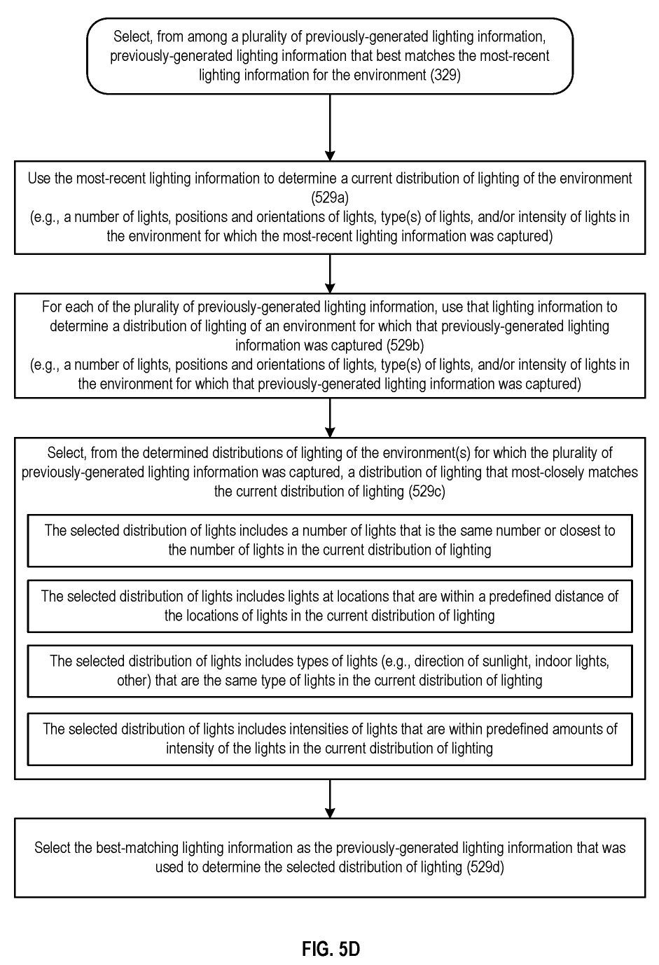

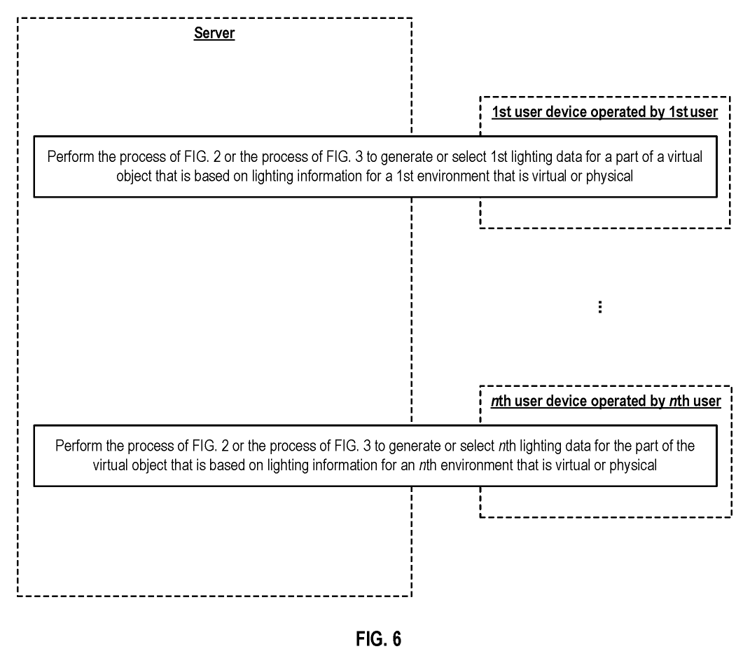

If new lighting data is needed after step 327, previously-generated lighting information (e.g., previously-collected or previously-determined lighting information) that best matches the most-recent lighting information received for the environment is selected from among a plurality of previously-generated lighting information (329). Each of the plurality of previously-generated lighting information of step 329 may be for any environment, including possibly the environment currently in view of the user operating the user device. Different embodiments of step 329 are provided in FIG. 5A through FIG. 5D, which are discussed after the discussion of FIG. 4A through FIG. 4C.

After step 329, lighting data that was generated using the selected, previously-generated lighting information is retrieved (e.g., from a storage device) (331), the retrieved lighting data is transmitted to the user device from the server (333), and the user device renders the retrieved lighting data for the part (335).

Lighting data for the part is also generated based on the most-recent lighting information received for the environment and optionally the current position of the virtual object using any known approach for generating lighting data using such information (337). The generated lighting data is transmitted to the user device from the server (339), and the user device renders the generated lighting data for the part (341).

If new lighting data is not needed after step 327, or if step 337 completes, the process waits for a new time period (343) before repeating steps 311 through 343 during the new time period.

Steps 329 through 335 can often be performed more quickly and/or with less computational cost than steps 337 through 341, which makes the process of FIG. 3 more advantageous in some applications than the process of FIG. 2. The process of FIG. 3 is one embodiment for determining which lighting data to send to a user device for rendering. The process shown in FIG. 3 may be modified for another embodiment where all steps of FIG. 3 except steps 337 through 341 are performed. The process shown in FIG. 3 may also be modified for yet another embodiment where steps 337 through 341 are performed only if each of the plurality of previously-generated lighting information fails a threshold test (e.g., the locations at which the plurality of previously-generated lighting information are not within a threshold maximum distance from a location of the user device, the times or days during which the plurality of previously-generated lighting information are not within threshold maximum amounts of time or numbers of days from the current time or current day, respective intensities of light determined from each of the plurality of previously-generated lighting information are each not within a threshold amount of intensity from the intensities of light determined from the most-recent lighting information, respective numbers of light sources determined from each of the plurality of previously-generated lighting information are each not within a threshold number from the number of light sources determined from the most-recent lighting information, respective positions of light sources determined from each of the plurality of previously-generated lighting information are each not within a threshold distance from the positions of light sources determined from the most-recent lighting information, respective directions of light sources determined from each of the plurality of previously-generated lighting information are each not within a threshold angle from the directions of light sources determined from the most-recent lighting information).

The process shown in FIG. 3 may be modified for yet another embodiment where steps 331 through 335 are performed only if the best-matching lighting information passes a threshold test (e.g., the location at which the best-matching lighting information is within the threshold maximum distance from the location of the user device, the time or day during which the best-matching lighting information is within the threshold maximum amount of time or number of days from the current time or current day, one or more intensities of light determined from the best-matching lighting information are each within a threshold amount of intensity from one or more intensities of light determined from the most-recent lighting information, a number of light sources determined from the best-matching lighting information is within a threshold number from the number of light sources determined from the most-recent lighting information, one or more positions of light sources determined from the best-matching lighting information are each within a threshold distance from one or more positions of light sources determined from the most-recent lighting information, one or more directions of light sources determined from the best-matching lighting information are within a threshold angle from one or more directions of light sources determined from the most-recent lighting information).

### Retrieving Virtual Object Data (Step 201, Step 301)

FIG. 4A, FIG. 4B and FIG. 4C each depict a different process performed by the server (e.g., the platform 110) for retrieving virtual object data during step 201 of FIG. 2 or step 301 of FIG. 3.

FIG. 4A is a flowchart of an embodiment of a process for retrieving virtual object data. The method of FIG. 4A can include the following steps: determine the current time of day for the user device (401a); and select, for inclusion with the virtual object data, particular default lighting data that was previously generated based on predefined lighting conditions for a time of day that matches or includes the current time of day (401b). Examples of times of day include an individual time (e.g., 12:13 PM, etc.), or ranges of times (e.g., ranges of times for sunrise lighting, morning lighting, noon lighting, afternoon lighting, sunset lighting, night lighting, or other types of lighting).

FIG. 4B is a flowchart of another embodiment of a process for retrieving virtual object data. The method of FIG. 4B can include the following steps: determine whether the environment is an indoor or outdoor environment (401a) (e.g., by correlating a location of the user device to a map of indoor and/or outdoor environments, or any known approach); (optionally) determine a characteristic of the indoor or outdoor environment (401b) (e.g., characteristics such as having unblocked or blocked light sources, directional light from particular directions, etc.); and select, for inclusion with the virtual object data, particular default lighting data that was previously generated based on predefined lighting conditions for the determined indoor or outdoor environment (and optionally determined for the characteristic) (401c).

FIG. 4C is a flowchart of another embodiment of a process for retrieving virtual object data. The method of FIG. 4C can include the following steps: retrieve/receive initial lighting information for the environment (401a) (e.g., similar to steps 223a and 225a, or steps 223b and 225b); and generate, for inclusion with the virtual object data, the default lighting data based on the initial lighting information for the environment (401b).

The processes of FIG. 4A, FIG. 4B and/or FIG. 4C can also be combined in any possible combination.

### Selecting Previously-generated Lighting Information that Best Matches the Most-recent Lighting Information for the Environment (Step 329)

FIG. 5A, FIG. 5B, FIG. 5C and FIG. 5D each depict a different process performed by the server (e.g., the platform 110) for selecting previously-generated lighting information that best matches the most-recent lighting information for the environment during step 329 of FIG. 3.

FIG. 5A is a flowchart of an embodiment of a process for selecting previously-generated lighting data that best matches the most-recent lighting information for the environment. The method of FIG. 5A can include the following steps: determine a location of the user device (529a); for each of the previously-generated lighting information, determine a location in the environment at which that previously-generated lighting information was captured (529b); select, from the determined locations at which the plurality of previously-generated lighting information were captured, a location that is closest to the location of the user device (529c); and select the best-matching lighting information as the previously-generated lighting information that was captured at the selected location (529d).

FIG. 5B is a flowchart of another embodiment of a process for selecting previously-generated lighting data that best matches the most-recent lighting information for the environment. The method of FIG. 5B can include the following steps: (optionally) determine a location of the user device, and select the plurality of previously-generated lighting information to include only previously-generated lighting information that were captured at locations that are within a threshold distance (e.g., d units of measurement) of the location of the user device (529a); determine a current day (e.g., May 12, August 7, etc.) (529b); for each of the plurality of previously-generated lighting information, determine a day during which that previously-generated lighting information was captured (529c); select, from the determined days during which the plurality of previously-generated lighting information were captured, a day (of the current year in one embodiment, or of any year in another embodiment) that is closest to the current day (529d); and select the best-matching lighting information as the previously-generated lighting information that was captured during the selected day (529e).

FIG. 5C is a flowchart of another embodiment of a process for selecting previously-generated lighting data that best matches the most-recent lighting information for the environment. The method of FIG. 5C can include the following steps: (optionally) determine a location of the user device, and select the plurality of previously-generated lighting information to include only previously-generated lighting information that were captured at locations that are within a threshold distance e.g., d units of measurement) of the location of the user device (529a); (optionally) determine a current day, and select the plurality of previously-generated lighting information to include only previously-generated lighting information that were captured during a range of days (e.g., the month of March, January 15-February 3, etc., of the current year in one embodiment, or of any number of years in another embodiment) that include the current day (529b); determine a current time of day (529c); for each of the plurality of previously-generated lighting information, determine a time of day during which that previously-generated lighting information was captured (529d); select, from the determined times of day during which the plurality of previously-generated lighting information were captured, a time of day (of the current day or any day) that is closest to the current time of day (529e); and/or select the best-matching lighting information as the previously-generated lighting information that was determined during the selected time of day (529f).

FIG. 5A through FIG. 5C are described for use with an environment within which a user operates an AR or MR user device. The same processes may be used for VR environments with lighting that changes over a period of time, where the locations are locations in those environments, the days are days for the VR environments (if days are used to determine lighting), and the times are times for the VR environments (if times are used to determine lighting).

FIG. 5D is a flowchart of another embodiment of a process for selecting previously-generated lighting data that best matches the most-recent lighting information for the environment. The method of FIG. 5D can include the following steps: use the most-recent lighting information to determine a current distribution of lighting of the environment (529a); for each of the plurality of previously-generated lighting information, use that lighting information to determine a distribution of lighting of an environment for which that previously-generated lighting information was captured (529b); select, from the determined distributions of lighting of the environment(s) for which the plurality of previously-generated lighting information was captured, a distribution of lighting that most-closely matches the current distribution of lighting (529c); and/or select the best-matching lighting information as the previously-generated lighting information that was used to determine the selected distribution of lighting (529d). Different types of distributions of lighting are contemplated, including: a number of lights, positions and orientations of lights, type(s) of lights, and/or intensities of lights in the environment for which the most-recent lighting information or previously-generated lighting information was captured). Examples of resultant selections during step 529c in FIG. 5D include: the selected distribution of lights includes a number of lights that is the same number or closest to the number of lights in the current distribution of lighting; the selected distribution of lights includes lights at locations that are within a predefined distance of the locations of lights in the current distribution of lighting; the selected distribution of lights includes types of lights (e.g., direction of sunlight, indoor lights, other) that are the same type of lights in the current distribution of lighting; and/or the selected distribution of lights includes intensities of lights that are within predefined amounts of intensity of the lights in the current distribution of lighting.

### Generating or Selecting Different Lighting Data for the Same Virtual Object in Response to Detecting Different Lighting Conditions in Different Virtual or Physical Environments

FIG. 6 is a flowchart of an embodiment of a process for generating or selecting different lighting data for the same virtual object in response to detecting different lighting conditions in different virtual or physical environments. The process of FIG. 6 can be performed cooperatively between the server (e.g., the platform 110) and the user device(s) 120. As shown in FIG. 6, a server is used with each of n user devices to perform a different implementation of the process of FIG. 2 or the process of FIG. 3 in order to generate or select different lighting data for a part of a virtual object that is based on different lighting information for a different virtual or physical environment, where n is two or more. By way of illustration, FIG. 6 shows the server and a first user device operated by a first user performing the process of FIG. 2 or the process of FIG. 3 to generate or select first lighting data for a part of a virtual object that is based on lighting information for a first environment that is virtual or physical, and so on until the server and an nth user device operated by a nth user perform the process of FIG. 2 or the process of FIG. 3 to generate or select nth lighting data for the part of the virtual object that is based on lighting information for an nth environment that is virtual or physical.

### Technical Solutions to Technical Problems

FIG. 6 illustrates that the processes of FIG. 2 and FIG. 3 can be repeated for any number of user devices on which the virtual object is to display (any number of VR devices, any number of AR devices, and any number of MR devices) such that lighting data for the virtual object that is generated based on lighting conditions of one environment in view of one user operating one user device is different than lighting data for the same virtual object that is generated based on lighting conditions of another environment in view of another user operating another user device. The processes of FIG. 2 and FIG. 3 not only generate different lighting data for the same virtual object that is responsive to changes in lighting conditions over time in the same environment, but also generate different lighting data for the same virtual object based on different lighting conditions of different environments in view of different users during the same or different time periods. Thus, the processes of FIG. 2 and FIG. 3 are advantageously agnostic as to (i) lighting conditions (e.g., real or virtual), (ii) environments (e.g., virtual and physical), and (iii) devices (e.g., VR, AR or MR devices). As a result, unique lighting data is determined for the same virtual object under different lighting conditions, in different environments, and/or on different user devices at any time, which solves a technical problem of allowing different users operating different devices in different environments to view the same virtual object with realistic lighting. When users collaborate with each other, each user that views a different environment sees the same virtual object but with different lighting for the different environment.

The processes of FIG. 2 and FIG. 3 provide many advantages over prior approaches.

An exemplary benefit of the processes of FIG. 2 and FIG. 3 is faster generation of lighting data that requires a significant amount of lighting calculations. Since the processing power of the server (e.g., cloud processing) is many times greater than processing power of a user device, new lighting data can be generated by the server more quickly than at the user device (e.g., generation within a few seconds rather than many minutes or over an hour at the user device). As a result, new lighting data can be generated by the server, and then distributed to the user device over time so lighting of a virtual object displayed within an environment is responsive to lighting changes of that environment over time. New lighting calculations that generate the new lighting data can be performed more quickly on the server, which allows for on-demand changes to lighting data that is applied to different parts of the virtual object at different times while lighting conditions in the environment that effect the visual appearance of light on textures of those parts change over time. Updating lighting data in response to changes in lighting conditions of an environment is not practical if lighting data were generated at the user device due to (i) the limited processing capability of the user device and the impractical length of time (e.g., many minutes or over an hour) needed to generate the new lighting data at the user device using that limited processing capability, and/or (ii) the significant reduction in battery power consumed by a mobile user device if that user device attempted to generate the new lighting data. Responsive generation of lighting data is not even possible at some user devices due to lack of processing capability of those user devices to generate a single instance of lighting data that is customized to an environment. The new functions of FIG. 2 and FIG. 3 solve technical problems of displaying virtual objects with realistic lighting on user devices that lack processing capability or battery power for generating lighting data that is needed to display the realistic lighting. Since the same server or cloud-based set of machines can determine different lighting data for different environments, (i) the costs of user devices can be reduced to include lower cost processors with less processing capability, and/or (ii) tethered devices can be untethered and also more mobile user devices can be used since battery usage needed to display virtual objects can be reduced. As a result, user devices become lower cost, have reduced weight and size, and are more available.

Another exemplary benefit of the processes of FIG. 2 and FIG. 3 is reduced compute costs and reduced transmission costs by selectively generating lighting data to update and send to a user device only when needed. In some embodiments, transmission of lighting data from the server to a user device may be streamed regardless of whether a change in lighting conditions has been detected (e.g., where step 227 of FIG. 2 is omitted). In other embodiments, transmission of lighting data from the server to a user device may be transmitted only in response to a change in lighting conditions that has been detected (e.g., where step 227 of FIG. 2 or step 327 of FIG. 3 is performed). Using a server to compute new lighting data over time as lighting conditions change allows for “dynamic” baked lighting that uses less processing power and time than dynamic lighting, but produces changes in lighting that is not possible when a single instance of baked lighting data is used. One drawback of fixed baked lighting is that the resultant lighting of a virtual object remains unchanged even when a light source in an environment changes (i) from light to dark, or dark to light, (ii) from a first position to a second position, (iii) from one color or intensity to another color or intensity, or (iv) or another change. As a result, the lighting shown on the virtual object does not seem real after the light source changes. The approaches disclosed herein overcome this drawback by updating the lighting data based on the changes. Transmitting on-demand lighting data based on detected changes from the server to a user device also uses less bandwidth than transmitting constant dynamic lighting data regardless of changes, which is another advantage of using the approaches described herein to provide lighting data for a virtual object. As a result, lighting of a virtual object is more realistic than prior baked lighting approaches, and the realistic lighting is produced at reduced processing and transmission costs compared to dynamic lighting approaches.

Further reduced compute costs are possible using the processes of FIG. 3 modified to exclude optional steps 337 through 341 or to limit when steps 337 through 341 occur. In particular, selection of previously-generated lighting data of the virtual object (e.g., lighting data that was generated for another user, user device, or even environment) can be computationally less costly than generating new lighting data based on current lighting conditions of an environment.

Yet another exemplary benefit of the processes of FIG. 2 and FIG. 3 is improved user experience that allows any user to view the same virtual object in any environment while experiencing realistic lighting data for the virtual object in that environment.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies.

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for operating a virtual environment comprising:
transmitting, by one or more processors, virtual object data to a user device for rendering a virtual object at the user device, the virtual object having one or more parts;
determining, during a current time period, a current position of the user device and a current position of a virtual object based on a mapping of the virtual environment received from the user device;
determining current lighting information for the virtual environment based on the current position, the lighting information including brightness information for of one or more light sources in the virtual environment during the current time period;
generating new lighting data for each part of the one or more parts of the virtual object for a subsequent time period after the current period of time; and
transmitting the new lighting data to the user device for each part of the virtual object.

2. The method of claim 1 further comprising generating the new lighting data for the subsequent time period based on at least one of:
a change in relative position between the user device and the virtual object,
a change in lighting information,
an absence of current lighting data; and
an expiration of a predefined time since the current lighting data.

3. The method of claim 1 further comprising:
selecting, from among a plurality of previously-generated lighting data previously-generated lighting information that best matches the current lighting information for the environment; and
transmitting previously-generated lighting data associated with the previously-generated lighting information to the user device based on the selecting.

4. The method of claim 3 further comprising generating the new lighting data for each part based on a most-recent lighting information for the environment and the current position of the virtual object if each of the plurality of previously-generated lighting data fails a threshold test.

5. The method of claim 3 further comprising:
determining a current distribution of lighting of the environment based on a most-recent lighting information; and
determining a distribution of lighting within the virtual environment for which the previously-generated lighting information was captured.

6. The method of claim 1, wherein determining the current lighting information for the virtual environment for an AR user device comprises capturing the current lighting information for a physical environment coincident with the virtual environment.

7. The method of claim 1, wherein determining the current lighting information for the virtual environment for a VR user device comprises retrieving the current lighting information for the environment.

8. The method of claim 1, wherein the current lighting information comprises a position of one or more light sources and brightness of the one or more light sources.

9. The method of claim 1 further comprising:
determining a current time of day for the user device; and
selecting, for inclusion with the virtual object data, default lighting data previously generated based on predefined lighting conditions for a time of day that matches or includes the current time of day.

10. The method of claim 1 further comprising:
determining whether the environment is an indoor or outdoor environment; and
selecting, for inclusion with the virtual object data, default lighting data previously generated based on predefined lighting conditions for the determined indoor or outdoor environment.

11. A non-transitory computer-readable medium for operating a virtual environment comprising instructions that when executed by one or more processors cause the one or more processors to:
transmit virtual object data to a user device for rendering a virtual object at the user device, the virtual object having one or more parts;
determine, during a current time period, a current position of the user device and a current position of a virtual object based on a mapping of the virtual environment received from the user device;
determine current lighting information for the virtual environment based on the current position, the lighting information including brightness information for of one or more light sources in the virtual environment during the current time period;
generate new lighting data for each part of the one or more parts of the virtual object for a subsequent time period after the current period of time; and
transmit the new lighting data to the user device for each part of the virtual object.

12. The non-transitory computer-readable of claim 11 further comprising instructions to cause the one or more processors to generate the new lighting data for the subsequent time period based on at least one of:
a change in relative position between the user device and the virtual object,
a change in lighting information,
an absence of current lighting data; and
an expiration of a predefined time since the current lighting data.

13. The non-transitory computer-readable of claim 11 further comprising instructions to cause the one or more processors to:
select, from among a plurality of previously-generated lighting data previously-generated lighting information that best matches the current lighting information for the environment; and
transmit previously-generated lighting data associated with the previously-generated lighting information to the user device based on the selecting.

14. The non-transitory computer-readable of claim 13 further comprising instructions to cause the one or more processors to generate the new lighting data for each part based on a most-recent lighting information for the environment and the current position of the virtual object if each of the plurality of previously-generated lighting data fails a threshold test.

15. The non-transitory computer-readable of claim 13 further comprising instructions to cause the one or more processors to:
determining a current distribution of lighting of the environment based on a most-recent lighting information; and
determining a distribution of lighting within the virtual environment for which the previously-generated lighting information was captured.

16. The non-transitory computer-readable of claim 11, wherein determining the current lighting information for the virtual environment for an AR user device comprises capturing the current lighting information for a physical environment coincident with the virtual environment.

17. The non-transitory computer-readable of claim 11, wherein determining the current lighting information for the virtual environment for a VR user device comprises retrieving the current lighting information for the environment.

18. The non-transitory computer-readable of claim 11, wherein the current lighting information comprises a position of one or more light sources and brightness of the one or more light sources.

19. The non-transitory computer-readable of claim 11 further comprising instructions to cause the one or more processors to sing:
determine a current time of day for the user device; and
select, for inclusion with the virtual object data, default lighting data previously generated based on predefined lighting conditions for a time of day that matches or includes the current time of day.

20. The non-transitory computer-readable of claim 11 further comprising instructions to cause the one or more processors to:
determine whether the environment is an indoor or outdoor environment; and
select, for inclusion with the virtual object data, default lighting data previously generated based on predefined lighting conditions for the determined indoor or outdoor environment.
